(19) United States
(12) Patent Application Publication
(10) Pub. No.: US 2026/0046760 A1
(43) Pub. Date: Feb. 12, 2026

(54) METHOD AND APPARATUS FOR TRANSMIT POWER CONTROL OF SYNCHRONIZATION SIGNAL AND BROADCAST CHANNEL IN NON-TERRESTRIAL NETWORK

(71) Applicant: ELECTRONICS AND TELECOMMUNICATIONS RESEARCH INSTITUTE, Daejeon (KR)

(72) Inventors: Jung Bin KIM, Daejeon (KR); Pansoo KIM, Daejeon (KR); Hee Wook KIM, Daejeon (KR); Gyeongrae IM, Daejeon (KR)

(73) Assignee: ELECTRONICS AND TELECOMMUNICATIONS RESEARCH INSTITUTE, Daejeon (KR)

(21) Appl. No.: 19/295,479

(22) Filed: Aug. 8, 2025

(30) Foreign Application Priority Data
Aug. 9, 2024 (KR) 10-2024-0107100
Aug. 6, 2025 (KR) 10-2025-0108402

(51) Int. Cl. H04W 48/20; H04W 48/02

(52) U.S. Cl. CPC H04W 48/20; H04W 48/02

(57) ABSTRACT

A method of a terminal may comprise: acquiring, from a first base station, first information indicating a difference between a reception power of a first reference beam of the first base station and a reception power of a first SSB beam of the first base station; receiving, from the first base station, second information indicating a difference between a reception power of a second reference beam of a second base station and a reception power of a second SSB beam of the second base station; measuring a first signal of the first base station; measuring a second signal of the second base station; and selecting a cell operated by the first base station or the second base station based on at least one of a first measurement result of the first signal, a second measurement result of the second signal, the first information, or the second information.

### CROSS-REFERENCE TO RELATED APPLICATIONS

This application claims priority to Korean Patent Applications No. 10-2024-0107100, filed on Aug. 9, 2024, and No. 10-2025-0108402, filed on Aug. 6, 2025, with the Korean Intellectual Property Office (KIPO), the entire contents of which are hereby incorporated by reference.

### BACKGROUND

### 1. Technical Field

The present disclosure relates to a transmit power control technique in a communication system, and more particularly, to a transmit power control technique for a synchronization signal and broadcast channel in non-terrestrial networks and terrestrial networks.

### 2. Related Art

To handle the rapidly increasing wireless data traffic, a communication network (e.g. new radio (NR) communication network) using a frequency band (e.g. frequency band above 6 GHz) higher than a frequency band (e.g. frequency band below 6 GHZ) of Long Term Evolution (LTE) (or LTE-A) is being considered. The NR communication network can support not only frequency bands below 6 GHz but also those above 6 GHz, and it can support a wider variety of communication services and scenarios compared to LTE communication networks. For example, usage scenarios of the NR communication network may include enhanced Mobile Broadband (eMBB), Ultra-Reliable Low Latency Communication (URLLC), and massive Machine Type Communication (mMTC).

The NR communication network can provide communication services to terminals located on terrestrial areas. Recently, the demand for communication services has been increasing not only for terrestrial environments but also for non-terrestrial environments such as airplanes, drones, and satellites. To address this, technologies for non-terrestrial networks (NTNs) are being discussed. A non-terrestrial network can be implemented based on NR technology. For example, in a non-terrestrial network, communication between a satellite and a communication node located on the ground or another communication node located in a non-terrestrial environment (e.g. airplanes, drones, etc.) can be performed based on NR technology. In such a network, a satellite can perform functions of a base station in the NR communication network.

Meanwhile, the satellite can transmit signals (e.g. synchronization signal block (SSB) signals) toward the same spatial area using multiple beams. The satellite can deactivate transmission of some SSBs. When the satellite uses narrow beams that are respectively allocated to different spatial areas, it may be required to transmit SSBs for all narrow beams in order to cover all the areas within a cell. In this case, the terminal may monitor all SSBs corresponding to all the narrow beams within the cell, which may increase the power consumption of the terminal. The satellite can simultaneously transmit signals using both wide beams and narrow beams. In this case, since a power allocated to each beam is reduced, it may be difficult to maintain the conventional cell coverage.

Meanwhile, in a 5G communication system, SSB may be transmitted with a periodicity ranging from a minimum of 5 ms to a maximum of 160 ms. A terminal may attempt to receive SSB according to the SSB transmission periodicity configured for the terminal. In a satellite communication system utilizing a large number of multiple beams, the number of beams that can be simultaneously used may be limited, and there may be beams whose use is temporarily suspended. While a beam is temporarily suspended, the terminal may fail to receive SSB at a configured SSB reception time.

The terminal may fail to receive some downlink signals or even all downlink signals. For example, if the time when the beam is temporarily suspended lasts for several hundred milliseconds or longer, the terminal may repeatedly attempt to receive synchronization signals (SSs) periodically over a long period of time. In such a case, the battery consumption of the terminal may increase. If a result of the reception attempt is regarded as a communication connection failure, all terminals belonging to the corresponding beam may attempt initial access procedures.

### SUMMARY

The present disclosure for resolving the above-described problems is directed to providing transmit power control methods and apparatuses for a synchronization signal and broadcast channel in non-terrestrial networks and terrestrial networks.

A method of a terminal, according to exemplary embodiments of the present disclosure, may comprise: acquiring, from a first base station, first information indicating a difference between a reception power of a first reference beam of the first base station and a reception power of a first synchronization signal block (SSB) beam of the first base station; receiving, from the first base station, second information indicating a difference between a reception power of a second reference beam of a second base station and a reception power of a second SSB beam of the second base station; measuring a first signal received from the first base station; measuring a second signal received from the second base station; and selecting a cell operated by at least one of the first base station or the second base station based on at least one of a first measurement result of the first signal, a second measurement result of the second signal, the first information, or the second information.

The first reference beam may be a narrow beam, and the first SSB beam may be a narrow beam.

The second reference beam may be a narrow beam, and the second SSB beam may be a wide beam.

The first signal may be a data signal received through the first reference beam or an SSB received through the first SSB beam.

The second signal may be a data signal received through the second reference beam or an SSB received through the second SSB beam.

The first information may include a first SSB reception power offset indicating a reception power difference between the first reference beam and the first SSB beam, and the second information may include a second SSB reception power offset indicating a reception power difference between the second reference beam and the second SSB beam.

The cell may be determined based on at least one of information determined based on the first measurement result and the first SSB reception power offset, or information determined based on the second measurement result and the second SSB reception power offset.

A terminal according to exemplary embodiments of the present disclosure may comprise at least one processor, wherein the at least one processor may cause the terminal to perform: acquiring, from a first base station, first information indicating a difference between a reception power of a first reference beam of the first base station and a reception power of a first synchronization signal block (SSB) beam of the first base station; receiving, from the first base station, second information indicating a difference between a reception power of a second reference beam of a second base station and a reception power of a second SSB beam of the second base station; measuring a first signal received from the first base station; measuring a second signal received from the second base station; and selecting a cell operated by at least one of the first base station or the second base station based on at least one of a first measurement result of the first signal, a second measurement result of the second signal, the first information, or the second information.

The first reference beam may be a narrow beam, and the first SSB beam may be a narrow beam.

The second reference beam may be a narrow beam, and the second SSB beam may be a wide beam.

The first signal may be a data signal received through the first reference beam or an SSB received through the first SSB beam.

The second signal may be a data signal received through the second reference beam or an SSB received through the second SSB beam.

The first information may include a first SSB reception power offset indicating a reception power difference between the first reference beam and the first SSB beam, and the second information may include a second SSB reception power offset indicating a reception power difference between the second reference beam and the second SSB beam.

The cell may be determined based on at least one of information determined based on the first measurement result and the first SSB reception power offset, or information determined based on the second measurement result and the second SSB reception power offset.

A method of a base station, according to exemplary embodiments of the present disclosure, may comprise: transmitting, to a terminal, first information indicating a difference between a reception power of a first reference beam of the first base station and a reception power of a first synchronization signal block (SSB) beam of the first base station; transmitting, to the terminal, second information indicating a difference between a reception power of a second reference beam of a second base station and a reception power of a second SSB beam of the second base station; transmitting, to the terminal, a first signal using the first reference beam or the first SSB beam; and performing communication with the terminal through a cell of the first base station selected based on at least one of the first information, the second information, a measurement result of a second signal transmitted by the second base station, or a measurement result of the first signal.

The first reference beam may be a narrow beam, and the first SSB beam may be a narrow beam.

The second reference beam may be a narrow beam, and the second SSB beam may be a wide beam.

The first information may include a first SSB reception power offset indicating a reception power difference between the first reference beam and the first SSB beam, and the second information may include a second SSB reception power offset indicating a reception power difference between the second reference beam and the second SSB beam.

According to the present disclosure, when a difference in reception power between an SSB and a physical layer channel for data transmission occurs in a communication system using large-scale multiple beams, an error in SSB-based measurement can be compensated for. By varying the beam size for SSB transmission, a reception power difference between SSB beams may occur. The present disclosure can compensate for such errors in SSB-based measurement. When a reception power difference between SSB beams occurs due to SSBs of different sizes, the present disclosure can achieve accurate measurement of the states of data and control channels, and improve the performance of handover, cell selection and reselection, power control, mobility procedures, and beam management operations. When the SSB transmission power is frequently varied and operated according to the present disclosure, it is not necessary to notify the terminal of the transmission power and the power difference information on each SSB and CSI-RS of a serving cell or a neighbor cell, thereby reducing overhead and latency.

### BRIEF DESCRIPTION OF DRAWINGS

FIG. 1 is a conceptual diagram illustrating exemplary embodiments of a non-terrestrial network.

FIG. 2 is a conceptual diagram illustrating exemplary embodiments of a non-terrestrial network.

FIG. 3 is a block diagram illustrating exemplary embodiments of an entity constituting a non-terrestrial network.

FIG. 4 is a conceptual diagram illustrating an SSB transmission time in a 5G system using multiple beams.

FIG. 5 is a conceptual diagram illustrating a satellite communication system using multiple beams.

FIG. 6 is a conceptual diagram illustrating a beam hopping operation process.

FIG. 7 is a conceptual diagram illustrating a beam hopping operation process.

FIG. 8 is a sequence chart illustrating a method of selecting a cell based on information indicating a difference between a reception power of a reference beam and a reception power of an SSB beam.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

In the present disclosure, a phrase including ‘when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

Exemplary embodiments according to the present disclosure will be described with respect to a communication network to which they are applied. The communication system may include a non-terrestrial network (NTN), a 4G communication network (e.g. long-term evolution (LTE) communication network), and/or a 5G communication network (e.g. new radio (NR) communication network). The 4G communication network and the 5G communication network may be classified as terrestrial networks.

The non-terrestrial network may operate based on LTE technology and/or NR technology. The non-terrestrial network can support communication not only in a frequency band of 6 GHz or lower but also in a frequency band higher than 6 GHz. The 4G communication network can support communication in a frequency band of 6 GHz or lower. The 5G communication network can support communication not only in a frequency band of 6 GHz or lower but also in a frequency band higher than 6 GHz. The communication network to which the exemplary embodiments according to the present disclosure are applied is not limited to the contents described below, and the exemplary embodiments according to the present disclosure can be applied to various communication networks (e.g. 4G communication network and/or 5G communication network). Here, the term “communication network” may be used in the same sense as “communication system”.

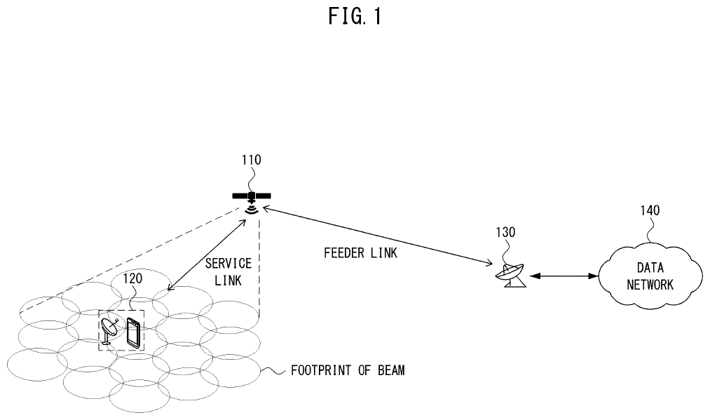

FIG. 1 is a conceptual diagram illustrating exemplary embodiments of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

The communication node 120 may include a communication node (e.g. a user equipment (UE), a terminal, or Internet of Things (IoT) device) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

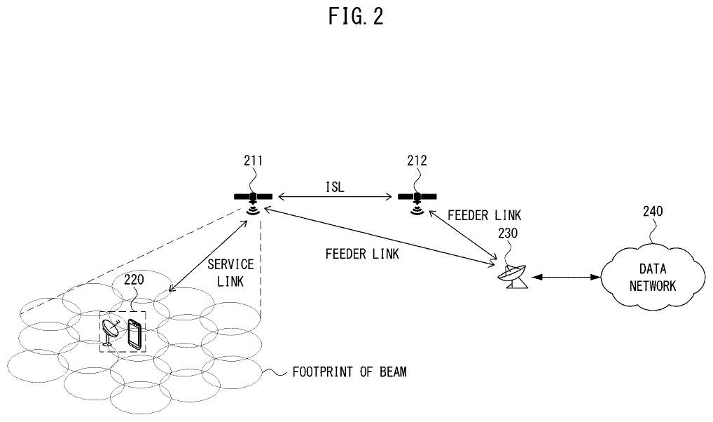

FIG. 2 is a conceptual diagram illustrating exemplary embodiments of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on payloads received from other entities (e.g. the communication node 220 or the gateway 230), and transmit the regenerated payloads.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

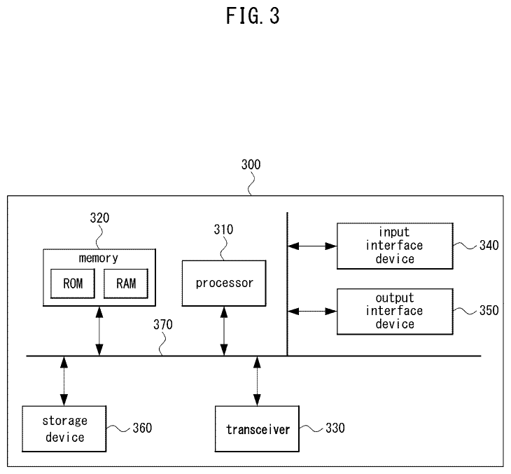

FIG. 3 is a block diagram illustrating exemplary embodiments of an entity constituting a non-terrestrial network.

Referring to FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’.

Parameters for the NTN reference scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |

| | |
|---|---|
| 1,200 | km |

| Spectrum (service link) | <6 GHz (e.g. 2 GHz) | | |
|---|---|---|---|
| | >6 GHz (e.g. DL 20 GHz, UL 30 GHz) | | |
| Maximum channel bandwidth | 30 MHz for band <6 GHz | | |
| capability | 1 GHz for band >6 GHz | | |
| (service link) | | | |
| Maximum distance between | 40,581 | km | 1,932 km (altitude of 600 km) |
| satellite and communication | | | 3,131 km (altitude of 1,200 km) |
| node (e.g. UE) at the minimum | | | |
| elevation angle | | | |
| Maximum round trip delay | Scenario A: 541.46 ms (service | | Scenario C: (transparent |
| (RTD) | and feeder links) | | payload: service and feeder |
| (only propagation delay) | Scenario B: 270.73 ms (only | | links) |
| | service link) | | −5.77 ms (altitude of 60 0km) |
| | | | −41.77 ms (altitude of 1,200 km) |
| | | | Scenario D: (regenerative |
| | | | payload: only service link) |
| | | | −12.89 ms (altitude of 600 km) |
| | | | −20.89 ms (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |

| | |
|---|---|
| within a cell | 3.18 ms (altitude of 1,200 km) |

| | |
|---|---|
| Service link | NR defined in 3GPP |
| Feeder link | Radio interfaces defined in 3GPP or non-3GPP |

In addition, in the NTN reference scenarios defined in Table 1, delay constraints may be defined as shown in Table 3 below.

TABLE 3

| | Scenario | Scenario | Scenario | | Scenario | |
|---|---|---|---|---|---|---|
| | A | B | C1-2 | | D1-2 | |
| Satellite altitude | 35,786 km | | 600 km | | | |
| Maximum RTD in a | 541.75 ms | 270.57 ms | 28.41 | ms | 12.88 | ms |
| radio interface between | (worst | | | | | |
| base station and UE | case) | | | | | |
| Minimum RTD in a | 477.14 ms | 238.57 ms | 8 | ms | 4 | ms |
| radio interface between | | | | | | |
| base station and UE | | | | | | |

Hereinafter, methods for transmission power control in a communication system are described. Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a terminal is described, a base station corresponding thereto may perform an operation corresponding to the operation of the terminal. Conversely, when an operation of a base station is described, a corresponding terminal may perform an operation corresponding to the operation of the base station.

In a communication system, a terminal may acquire time and frequency synchronization with a cell to be accessed for cell-based communication. The terminal may perform cell search to obtain a physical layer cell identifier (PCI) of the cell. When the cell search is performed, a base station may transmit synchronization signal (SS) and physical broadcast channel (PBCH) to the terminal. The terminal may receive SS and PBCH from the base station for cell access and may obtain required information from the base station. Multiple beam transmission and reception between the base station and the terminal may be possible. In this case, the base station may periodically transmit SSs and PBCHs to the terminal, which are respectively applied with different beams during a certain time duration. The terminal may receive SSs and PBCHs, which are respectively applied with different beams, from the base station. The terminal may select a beam that provides the highest reception signal power. The periodically transmitted SS may be used for coverage measurement, channel impulse response (CIR) measurement, interference measurement, or beamforming evaluation. For handover supporting access to a neighbor cell, measurement of SS of neighbor cells may be considered. Meanwhile, SS may include at least one of a primary synchronization signal (PSS) or a secondary synchronization signal (SSS). A synchronization signal block (SSB) may include at least one of PSS, SSS, or PBCH. The base station may periodically transmit SSB. The terminal may receive SSB and may obtain information required for cell access.

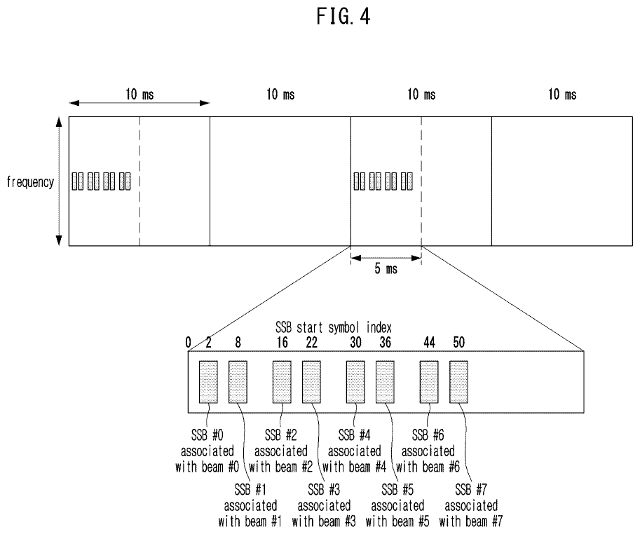

FIG. 4 is a conceptual diagram illustrating an SSB transmission time in a 5G system using multiple beams.

Referring to FIG. 4, in a wireless mobile communication system, a terminal may acquire time and frequency synchronization with a cell to be accessed for cell-based communication. The terminal may perform cell search to obtain a PCI of the cell to be accessed. A base station of the cell may transmit SS/PBCH blocks to the terminal. In the cell search, the terminal may receive SS/PBCH block(s) transmitted from the base station of the cell for cell access and may obtain required information. When multiple beam transmission and reception between the base station and the terminal are possible, the base station may periodically transmit SS/PBCH blocks, each of which is applied with a different beam, during a certain time duration. The terminal may receive SS/PBCH block(s), each of which is applied with a different beam. The terminal may select a beam having the highest reception signal strength among different beams.

In addition, the base station may periodically transmit SS. The periodically transmitted SS may be used for coverage measurement, CIR measurement, interference measurement, or beamforming evaluation. For handover supporting access to a neighbor cell, the terminal may measure SS of neighbor cells. For example, in the 5G system, SS may be defined as PSS and SSS. SS may be defined as an SSB composed of PSS, SSS, and PBCH. The base station may periodically transmit SSB. The terminal may receive SSB(s) from the base station and may obtain information required for cell access. FIG. 4 illustrates an SSB transmission time when a carrier frequency is between 3 GHz and 6 GHz and a subcarrier spacing is 15 kHz. A total of 8 SSBs (SSB #0 to SSB #7) may be transmitted during a 5 ms duration using different beams (beam #0 to beam #7). The 8 SSBs may be transmitted with a periodicity of 20 ms. The terminal may obtain a PCI using PSS and SSS within SSB. The terminal may obtain essential information on the cell using PBCH. Among information transmitted through PBCH, a 56-bit payload for PBCH may include contents shown in Table 4.

TABLE 4

| Information | Number of bits |
|---|---|
| System frame number | 10 |
| Subcarrier spacing | 1 |
| SSB subcarrier offset | 5 (FR1) or 4 (FR2) |
| DMRS-type-A-position | 1 |
| Configuration of PDCCH for SIB 1 | 8 |
| Cell barring information flag | 1 |
| Intra-frequency reselection allowed/not allowed flag | 1 |
| SSB index | 0 (FR1) or 3 (FR2) |
| Half-frame bit | 1 |
| Spare bits | 1 |
| Reserved bits | 2 (FR1) or 0 (FR2) |
| BCCH-BCH-message type indication | 1 |
| CRC bits | 24 |

FR1 may refer to a frequency range 1 below 6 GHz. FR2 may refer to a frequency range 2 above 24 GHz. Referring again to FIG. 4, in FR1, the terminal may identify information (SSB index information) of an SSB start symbol index using one of 8 scrambling sequences of PBCH. In the case of FR2, the terminal may distinguish up to 64 SSB indexes using 8 scrambling sequences of PBCH together with 3-bit SSB index information transmitted through PBCH and may identify each SSB index information. Only some of all SSBs may be transmitted.

Based on Table 5, information on a transmitted SSB may be obtained by using at least one of 8-bit inOneGroup information and 8-bit groupPresence information in ssb-PositionsInBurst of ServingCellConfigCommonSIB information included in a system information block (SIB) 1. Based on Table 6, information on a transmitted SSB may be obtained by using at least one of 4-bit shortBitmap information, 8-bit mediumBitmap information, or 64-bit longBitmap information in ssb-PositionsInBurst of ServingCellConfigCommon information provided through radio resource control (RRC) reconfiguration signaling. In a standalone case, information on SSB transmission may be transmitted through SIB 1. In a non-standalone case, information on SSB transmission may be transmitted through an RRC reconfiguration message. For example, information on SSB transmission in SIB 1 may be as shown in Table 5. For example, information on SSB transmission in an RRC reconfiguration message may be as shown in Table 6.

TABLE 5
ServingCellConfigCommonSIB

| | | |
|---|---|---|
| ssb-PositionsInBurst | inOneGroup | BIT STRING (SIZE (8)) |
| | groupPresence | BIT STRING (SIZE (8) |

| | |
|---|---|
| ssb-periodicityServingCell | ENUMERATED {5ms, 10ms, 20ms, 40ms, |
| | 80ms, 160ms} |

TABLE 6
ServingCellConfigCommon

| | | |
|---|---|---|
| ssb-PositionsInBurst | shortBitmap | BIT STRING (SIZE (4)) |
| | mediumBitmap | BIT STRING (SIZE (8)) |
| | longBitmap | BIT STRING (SIZE (64)) |

| | |
|---|---|
| ssb-periodicityServingCell | ENUMERATED {5ms, 10ms, 20ms, 40ms, |
| | 80ms, 160ms, spare2, spare1} |

Table 7 illustrates information on SSB transmission in the RRC reconfiguration message. NTN-Config-r17 may be an information element including configuration information for NTN operations in 3GPP Release 17. In 5G NTN, a communication distance between a satellite and a ground terminal or between the satellite and a ground base station may be several hundred km or more. Therefore, channel characteristics may be very different from those of an existing terrestrial network (TN). In order to provide services by distinguishing an existing TN terminal and an NTN terminal, an additional SIB 19 may be defined. By defining the SIB 19, the base station may transmit information on NTN operations to NTN terminals. The terminals may receive information on NTN operations from the base station. For example, information on NTN configuration in the SIB 19 may be as shown in Table 7. Meanwhile, in satellite communication using multiple beams, each beam may be allocated to a spatially different area.

TABLE 7
NTN-Config-r17

| | |
|---|---|
| epochTime-r17 | Epoch Time-r17 OPTIONAL |
| ntn-UlSyncValidityDuration- | ENUMERATED {s5, s10, s15, s20, s25, s30, s35, s40, |
| r17 | s45, s50, s55, s60, s120, s180, s240} OPTIONAL |
| cellSpecificKoffset-r17 | INTEGER(0...1023) OPTIONAL |
| kmac-r17 | INTEGER(0...512) OPTIONAL |
| ta-Info-r17 | TAInfo-r17 OPTIONAL |
| ntn-PolarizationDL-r17 | ENUMERATED {rhcp, lhcp, linear} OPTIONAL |
| ntn-PolarizationUL-r17 | ENUMERATED {rhcp, lhcp, linear} OPTIONAL |
| ephemerisInfo-r17 | EphemerisInfo-r17 OPTIONAL |
| ... | ... |

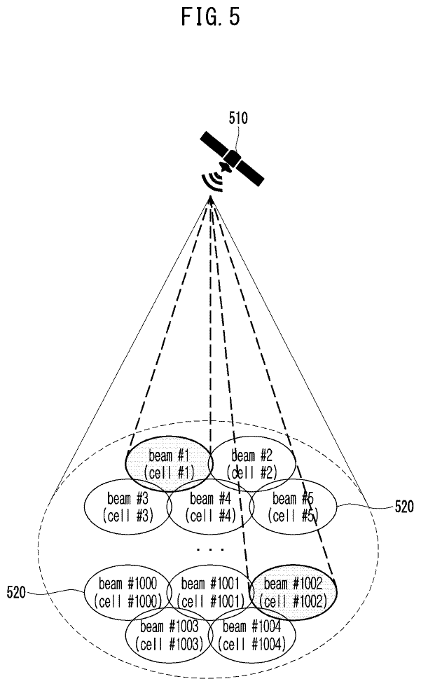

FIG. 5 is a conceptual diagram illustrating a satellite communication system using multiple beams.

Referring to FIG. 5, a first beam (beam #1) may be allocated to a corresponding first cell (cell #1). A second beam (beam #2) may be allocated to a corresponding second cell (cell #2). Terminals included within each beam coverage 520 of a satellite 510 may obtain a synchronization signal and system information of the corresponding cell based on SSB. Restrictions on a transmission power and constraints on management and operation of beams may exist for the satellite 510. When the number of beams supported by the satellite 510 is hundreds or even thousands, the number of beams available simultaneously (i.e. the number of beams activated simultaneously) may be limited due to the restrictions of the satellite. In order to provide services to terminals within hundreds or thousands of satellite beam coverages, a beam hopping scheme may be used. The beam hopping scheme may be applied based on time division. For example, all beams may be divided into several groups. Each group may be hopped by a time division scheme, and only some beams may be activated simultaneously. During a time when a beam accessed by a terminal is not used (i.e. during a time when the beam is not activated), the terminal may have difficulty in receiving at least one of synchronization signal (i.e. SSB), system information, or data. The problem of difficulty in SSB reception by the terminal may greatly affect operations of the terminal and quality of communication services. For example, FIG. 5 illustrates a scenario of operating each small beam as a different cell. The scenario may correspond to a case of allocating a different PCI to each beam. The scenario may also operate each small beam as a beam ID. The scenario may also use a cell ID and a beam ID in combination.

For example, in a frequency band below 3 GHz, a base station may operate four satellite small beams using one PCI and different beam IDs. In the satellite communication system, SSB may be transmitted with a periodicity of at least 5 ms and up to 160 ms. The base station may configure SSB to have a periodicity of 20 ms for initial access of a terminal. The terminal may attempt to receive SSB according to the SSB transmission periodicity set by the base station.

Meanwhile, in a satellite communication system using large-scale multiple beams, the number of simultaneously usable beams may be limited. In this case, beams that are temporarily not used may exist. For example, one satellite may operate 1058 small beams, and due to a transmission power constraint of the satellite, there may be a case where the number of beams that can be simultaneously activated (i.e. turned on) is 106. In this case, the satellite network may configure a beam group (or a beam set) each including 106 beams. The satellite network may operate beam hopping. During beam hopping operations, beams that are temporarily suspended or turned off may exist.

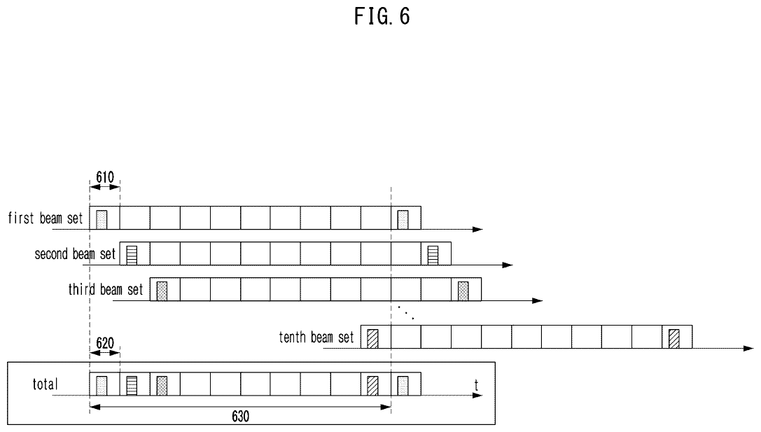

FIG. 6 is a conceptual diagram illustrating a beam hopping operation process.

Referring to FIG. 6, a power-on time of a beam may be defined as a dwell time 610 or 620. The dwell time 610 or 620 may be 1 ms. FIG. 6 illustrates a method of operating by setting dwell times for control information transmission and data transmission equally between beam groups. The number of beam sets may be 10. The dwell time of each beam may be equally set to 2 ms for operations. Alternatively, the dwell time of each beam may be set differently for operations. Alternatively, the dwell time of control information including SSB may be set equally between beam groups, and the dwell time for data transmission may be set differently between beam groups. An SSB periodicity 630 may also be referred to as an SSB revisit time.

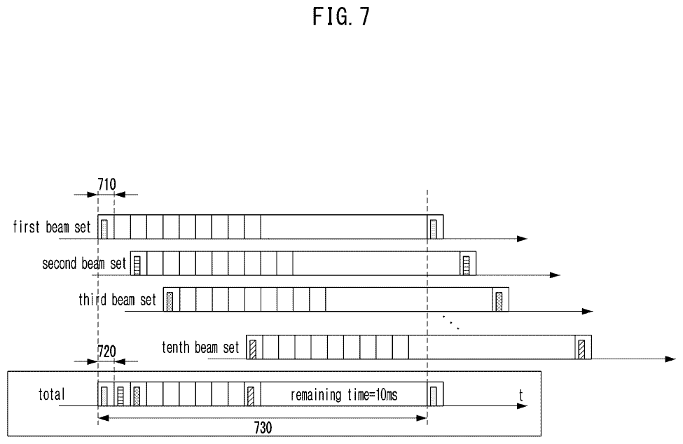

FIG. 7 is a conceptual diagram illustrating a beam hopping operation process.

Referring to FIG. 7, an SSB periodicity 730 may be 20 ms. A dwell time 710 or 720 may equally be 1 ms. FIG. 7 illustrates a method of operating by setting a dwell time of control information transmission including SSB equally between beam groups and setting a dwell time for data transmission differently between beam groups. When operating large-scale beams using beam hopping, a time during which a beam is temporarily suspended may exist. During the time when a beam is temporarily suspended, terminals may be unable to receive SSB at a configured SSB reception time. For beam hopping operations, cell discontinuous transmission/reception (DTX/DRX) may be used. A terminal may attempt transmission and reception only at a time when a group to which the terminal belongs is turned on. The terminal may switch to a sleep mode at a time when the group to which the terminal belongs is turned off, and energy consumption of the terminal may be reduced.

Referring again to FIG. 7, system information may include SSB. In the satellite communication system based on beam hopping, the base station may periodically transmit system information to terminals. Terminals may receive system information from the base station. In order to periodically transmit system information, the base station may need to turn on each beam group at every period of the system information. For example, for SSB transmission with a periodicity of 20 ms, each beam group may be turned on every 20 ms, and the base station may transmit SSB. When the satellite communication system based on beam hopping operates large-scale satellite beams, the number of beam sets (or groups) may increase, and the dwell time in which each beam set is turned on may decrease. Meanwhile, the method of FIG. 7 requires periodic transmission of system information. Problems of overhead increase and reduction of data throughput may occur.

In order to solve the above-described overhead problem, a method of increasing the transmission periodicity of system information may be provided. For example, when each beam group has the same dwell time, the base station may set the dwell time equally (e.g. 32 ms, 64 ms, or 128 ms). Alternatively, the base station may set the dwell time of each beam group differently. Alternatively, the base station may set the dwell time of control information transmission including SSB equally between beam groups and may set the dwell time for data transmission differently between beam groups. The existing (or legacy) terminal may not be able to support the increased system transmission periodicity. When a temporarily suspended time of a beam is hundreds of milliseconds or more, the terminal may periodically perform SSB reception for a long time. Due to the periodic SSB reception operation, battery consumption of the terminal may increase. If SSB is not received for a long time and is regarded as a communication connection failure, a problem may occur where all terminals belonging to the beam attempt initial access.

When a periodicity longer than the system information transmission periodicity supported by the existing standard is introduced, a problem may occur in the existing terminals that comply with the existing standard. A terminal in a power-off state located in a beam suspended for hundreds of ms or more may be powered on and attempt initial access. The terminal that attempts initial access may mistakenly determine that there is no serving communication network. When the suspended time of the beam is greater than the system information periodicity (e.g. when a periodicity of SSB is 20 ms or more or when a periodicity of SIB 1 and SIB 19 is 160 ms or more), a problem of erroneous determination of the terminal may occur. The cell DTX/DRX of Release-18 may target RRC_CONNECTED mode UEs. Since it does not include improvement for SSB transmission, the above-described problem may occur even when cell DTX/DRX is used. A method of increasing a transmission periodicity of SSB to solve the overhead problem may cause difficulty in services for the existing terminals.

In the present disclosure, a size of a beam may mean a width or a spatial coverage range of the beam. In order to solve the above-described overhead problem, a method of using a data transmission beam and a system information transmission beam with different dynamic coverages may be provided. For example, periodic system information including SSB may use a wide beam, and data transmission may use a narrow beam. A coverage of a beam for periodic system information transmission may include coverages of n beams for data transmission. n may be 1, 2, 4, or 8. Alternatively, n may be 1, 2, 4, 8, 16, 32, or 64. For example, the base station may dynamically configure sizes of system information transmission beams and the data transmission beams. The size of data transmission beam may be fixed, and the size of system information transmission beam may be adjusted. When the base station operates dynamic beam coverages, the terminal may receive a signal from each beam. A reception power of the signal at the terminal may vary. For example, when a wide beam is used for SSB and system information transmission, a reception power of SSB at the terminal may decrease.

Meanwhile, in order to maintain quality of communication services, the base station may perform data transmission other than SSB. When the base station transmits a physical layer channel, the base station may use a transmission power higher than a transmission power of SSB. When the base station transmits data through a physical layer data channel (e.g. PBCH), the base station may transmit the data using a narrow beam. A difference between a reception power of SSB and a reception power of the physical layer data channel may occur. Due to the difference in reception powers, accuracy of coverage measurement, CIR measurement, interference measurement, or beamforming evaluation based on SSB may decrease. In a communication system, various methods may exist to improve accuracy of measurement on different reference signals (RS). For example, the base station may provide information on a transmission power offset between SSB and non-zero power channel state information reference signal (NZP-CSI-RS) to the terminal and may improve accuracy during channel measurement through different reference signals.

Meanwhile, in a wireless mobile communication system using large-scale multiple beams, SSB transmission may use a wide beam, and data and control channel transmission may use a narrow beam. A difference between a reception power of SSB and a reception power of a physical layer channel for data and control information transmission may occur. Due to the difference in reception power, an error in coverage measurement, CIR measurement, interference measurement, or beamforming evaluation based on SSB may greatly occur. When a size of a beam transmitting SSB is changed, its reception power may vary. The terminal may not be able to distinguish a cause of the variation in the reception power only with information on the transmission power offset between SSB and NZP-CSI-RS. Therefore, there is a need to support accurate SSB-based measurement. Delivery of information on a transmission scheme that may affect a difference in reception power of SSB to terminals may be required. In other words, methods for transmitting and receiving control information informing of a difference in reception power between a data beam and an SSB beam caused by a change in SSB beam size may be required.

When sizes of beams used for SSB transmission by a serving cell (or an operating cell) and a neighbor cell are different from those of their data beams (e.g. when the serving cell performs transmission using a wide beam and the neighbor cell performs transmission using a narrow beam), a difference between a reception power at the serving cell and a reception power at the neighbor cell may occur. Due to the difference in reception power, a problem of an incorrect handover may occur during measurement on a synchronization signal of the neighbor cell. For example, in the serving cell, the SSB beam and the data beam may have the same size, while in the neighbor cell, the SSB beam may be wider than its data beam. In this case, even when a reception power of the data beam of the neighbor cell is higher than a reception power of the serving cell, the terminal may incorrectly determine that the reception power of the neighbor cell is lower and may not perform a handover. In an opposite case, the terminal may perform an incorrect handover. In order to solve the above-described problem, a transmission and reception method for control information informing of a difference between a reception power at the serving cell and a reception power at the neighbor cell due to a difference in beam sizes may be provided.

In the present disclosure, in a communication system using large-scale multiple beams, in order to increase coverage of SSB, a base station may perform SSB transmission by adjusting a size of an SSB beam. A method of transmitting and receiving control information on an SSB transmission scheme may be provided. In other words, when a size of an SSB beam of the serving cell and a size of an SSB beam of the neighbor cell are different, the terminal may accurately measure SSB of the neighbor cell. To this end, a method of providing the terminal with information on a difference between a reception power of a data signal for a reference beam and a reception power of an SSB received through the neighbor cell may be provided.

In the present disclosure, when a size of an SSB beam is the same as a size of a beam for physical layer channel transmission, the beam may be regarded as a beam having the same size as a size of a reference beam. When the size of SSB beam is changed, the base station may transmit to the terminal information on a difference between a reception power of a data signal for the reference beam and a reception power of SSB for the SSB beam. The reference beam defined in the present disclosure may refer to a beam operated to have the same size as a beam for data and control channel transmission. A wide beam may mean a beam having a size larger than the beam for data and control channel transmission. A narrow beam may mean a beam having a size smaller than the beam for data and control channel transmission. However, the above definition is only for convenience of understanding of the present disclosure and is not intended to limit a scope of the present disclosure. For example, the reference SSB beam may be a beam used in the existing system, or the reference beam may be a beam that does not accompany a change in SSB beam size. The reference beam may also be a beam operated in a system that uses only a single size of SSB beam. For example, a data channel and a control channel may be transmitted using a narrow beam, and SSB may be transmitted using a wide beam. In this case, the reference beam may be a narrow beam for data and control channel transmission.

[Method 1: a Method in which an Operating Cell (or a Serving Cell or a First Base Station) Informs a Terminal of a Difference Between a Reception Power of a Reference Beam of a Neighbor Cell (or a Second Base Station) and a Reception Power for an SSB Beam of the Neighbor Cell (or the Second Base Station)]

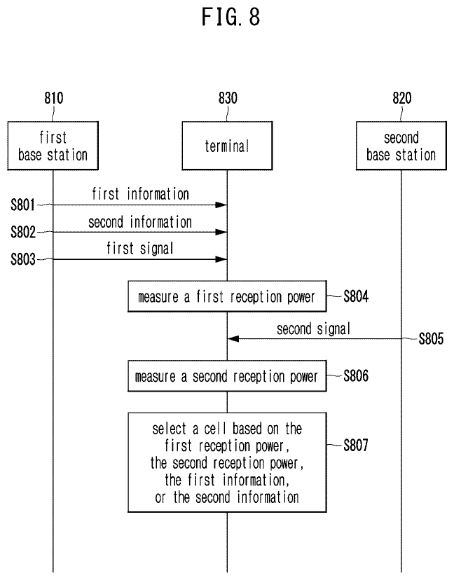

FIG. 8 is a sequence chart illustrating a method of selecting a cell based on information indicating a difference between a reception power of a reference beam and a reception power of an SSB beam.

Referring to FIG. 8, a first exemplary embodiment of Method 1 may be as shown in Table 8 and Table 9. The first exemplary embodiment may correspond to a case of adding an SSB reception power offset (SSBRxPoweroffset) to a gap configuration (GapConfig) message defined in measurement gap configuration (MeasGapConfig) information. Sizes of SSB beams may be set differently between cells. A first base station 810 may implicitly provide (or transmit) or explicitly transmit (or provide) first information to a terminal 830. Alternatively, the first base station 810 may transmit the first information implicitly. The terminal 830 may implicitly acquire (or receive) the first information through measurement of the terminal or explicitly receive (or acquire) the first information from the first base station 810. The first information may indicate a difference between a reception power for a first reference beam of the first base station 810 and a reception power for a first SSB beam of the first base station 810 (S801). The first information may include a first SSB reception power offset indicating the difference in reception power between the first reference beam and the first SSB beam. The first base station 810 may transmit second information to the terminal 830. The terminal 830 may receive the second information from the first base station. The second information may indicate a difference between a reception power for a second reference beam of the second base station 820 and a reception power for a second SSB beam of the second base station 820 (S802). The second information may include a second SSB reception power offset indicating a difference in reception power between the second reference beam and the second SSB beam. The first reference beam may be a narrow beam. The second reference beam may be a narrow beam. The first SSB beam may be a narrow beam. The second SSB beam may be a wide beam. The first base station 810 may transmit a first signal to the terminal 830 using the reference beam or the SSB beam. The terminal 830 may receive the first signal from the first base station 810 (S803). The terminal 830 may measure the first signal received from the first base station 810 (S804). The first signal may be a data signal received through the first reference beam or an SSB received through the first SSB beam. The second base station 820 may transmit a second signal to the terminal 830 using the reference beam or the SSB beam. The terminal 830 may receive the second signal from the second base station 820 (S805). The terminal 830 may measure the second signal received from the second base station 820 (S806). The second signal may be a data signal received through the second reference beam or an SSB received through the second SSB beam. The terminal 830 may select a cell operated by at least one of the first base station 810 or the second base station 820 based on at least one of a first measurement result of the first signal, a second measurement result of the second signal, the first information, or the second information (S807). A base station of the selected cell may perform communication with the terminal 830 through the cell selected based on at least one of the first information, the second information, the first measurement result, or the second measurement result.

TABLE 8
MeasGapConfig

| | |
|---|---|
| gapFR2 | SetupRelease {GapConfig} |
| gapFR1 | SetupRelease {GapConfig} |
| gapUE | SetupRelease {GapConfig} |

Based on Table 8, a GapConfig message may be defined in measurement gap configuration (MeasGapConfig) information. The operating cell (or the serving cell or the first base station) may set an SSBRxPoweroffset indicating information on a difference between a reception power for a reference beam of the neighbor cell (or the second base station) and a reception power for an SSB beam of the neighbor cell (or the second base station) in the GapConfig message. The measurement gap configuration information may support three different measurement gap configurations. In other words, the measurement gap configuration information may include at least one of gapFR2, gapFR1, or gapUE1 information. Exemplary embodiments of Method 1 may correspond to cases of adding parameters to the GapConfig message defined in the measurement gap configuration information. gapFR1 may be measurement gap configuration information that may be applied only in FR1 including a sub-6 GHz frequency band. gapFR2 may be measurement gap configuration information that may be applied only in FR2 including a frequency band of 24 GHz or higher. gapUE may be measurement gap configuration information that may be applied in all frequency bands.

TABLE 9
GapConfig

| | |
|---|---|
| gapOffset | INTEGER {0...159} |
| Measurement gap length | ENUMERATED {1.5ms, 3ms, 3.5ms, 4ms, |
| (MGL) | 5.5ms, 6ms} |
| Measurement gap repetition | ENUMERATED {20ms, 40ms, 80ms, |
| periodicity (MGRP) | 160ms} |
| Measurement gap timing | ENUMERATED {0ms, 0.25ms, 0.5ms} |
| advance (MGTA) | |
| SSBRxPoweroffset | ENUMERATED {0dB, −6dB} OPTIONAL |
| refServCellIndicator | ENUMERATED {pCell, pSCell, mcg-FR2} |

Information of the GapConfig message of the measurement gap configuration information configured by RRC signaling may be as shown in Table 9. The base station may generate the GapConfig message based on the measurement gap configuration information. Referring to Table 9, gapOffset may indicate a measurement start subframe within an execution period of measurement as an offset value of a measurement time, and a range of the offset value may be 0 to 159. A measurement gap length may indicate a time duration of a measurement operation and may indicate 1.5 ms, 3 ms, 3.5 ms, 4 ms, 5.5 ms, or 6 ms. A measurement gap repetition periodicity may indicate an execution periodicity of a measurement operation and may indicate 20 ms, 40 ms, 80 ms, or 160 ms. A measurement gap timing advance may indicate a correction value by which the terminal adjusts a reception timing to match an arrival time of a neighbor-cell SSB in a measurement gap and may indicate Oms, 0.25 ms, or 0.5 ms. A refServCellIndicator may indicate which serving cell is referenced when the terminal operates and may indicate at least one of pCell, pSCell, or mcg-FR2.

Referring to Table 8 and Table 9, the first information may be implicitly provided through configuration of the operating cell (or the serving cell or the first base station) and measurement of the terminal or may be explicitly transmitted through system information (i.e. SIB 1 or SIB 19) of the operating cell (or the serving cell or the first base station). The second information may include an SSB reception power offset indicating a reception power difference between the second reference beam and the second SSB beam. The operating cell (or the serving cell or the first base station) may explicitly transmit to the terminal the reception power difference between the reference beam of the neighbor cell (or the second base station) and the SSB beam of the neighbor cell (or the second base station). The SSB reception power offset set to 0 dB may indicate that a reception power of a data signal for the reference beam of the neighbor cell (or the second base station) and a reception power of an SSB for the SSB beam of the neighbor cell (or the second base station) are the same. The SSB reception power offset set to −6 dB may indicate that a reception power of an SSB for the SSB beam of the neighbor cell (or the second base station) is one-fourth of a reception power of a data signal for the reference beam of the neighbor cell (or the second base station) (i.e. a case where the SSB beam is a wide SSB beam). A second exemplary embodiment of Method 1 may be as shown in Table 10 and Table 11. Referring to Table 10, a GapConfig message may be defined in measurement gap configuration information. According to the present disclosure, three different measurement gap configurations may be possible. In other words, the measurement gap configuration information may include at least one of gapFR2, gapFR1, or gapUE1 information. Information of the GapConfig message of the measurement gap configuration information configured through RRC signaling may be as shown in Table 11.

TABLE 10
MeasGapConfig

| | |
|---|---|
| gapFR2 | SetupRelease {GapConfig} |
| gapFR1 | SetupRelease {GapConfig} |
| gapUE | SetupRelease {GapConfig} |

TABLE 11
GapConfig

| | |
|---|---|
| GapOffset | INTEGER {0...159} |
| Measurement gap length | ENUMERATED {1.5ms, 3ms, 3.5ms, 4ms, |
| (MGL) | 5.5ms, 6ms} |
| Measurement gap | ENUMERATED {20ms, 40ms, 80ms, 160ms} |
| repetition periodicity | |
| (MGRP) | |
| Measurement gap | ENUMERATED {0ms, 0.25ms, 0.5ms} |
| timing advance | |
| (MGTA) | |
| SSBRxPoweroffset | ENUMERATED {0dB, −3dB, −5dB, −6dB} |
| | OPTIONAL |
| RefServCellIndicator | ENUMERATED {pCell, pSCell, mcg-FR2} |

Referring to Table 11, the second exemplary embodiment may correspond to a case where an SSB reception power offset (SSBRxPoweroffset) is added to the GapConfig message. The second information may include an SSB reception power offset indicating a reception power difference between the second reference beam and the second SSB beam. The SSBRxPoweroffset may indicate at least one of 0 dB, −3 dB, −5 dB, or −6 dB.

The SSB reception power offset set to 0 dB may indicate that a reception power of a data signal for the reference beam of the neighbor cell and a reception power of an SSB for the SSB beam of the neighbor cell are the same. The SSB reception power offset set to −3 dB may indicate that a reception power of an SSB for the SSB beam of the neighbor cell (or the second base station) is half a reception power of a data signal for the reference beam of the neighbor cell (i.e. a case where the SSB beam is a wide beam). The SSB reception power offset set to −5 dB may indicate that a reception power of an SSB for the SSB beam of the neighbor cell (or the second base station) is one-third of a reception power of a data signal for the reference beam of the neighbor cell (i.e. a case where the SSB beam is a wide beam). The SSB reception power offset set to −6 dB may indicate that a reception power of an SSB for an SSB beam of the neighbor cell is one-fourth of a reception power of a data signal for the reference beam of the neighbor cell (i.e. a case where the SSB beam is a wide beam).

A third exemplary embodiment of Method 1 may be as shown in Table 12 and Table 13. Referring to Table 12, the third exemplary embodiment of Method 1 may correspond to a case where parameters are added to a GapConfig message defined in measurement gap configuration information. According to the present disclosure, three different measurement gap configurations may be possible. In other words, the measurement gap configuration information may include at least one of gapFR2, gapFR1, or gapUE1 information. The GapConfig message may be defined in the measurement gap configuration information. Information of the GapConfig message in the measurement gap configuration information configured through RRC signaling may be as shown in Table 13.

TABLE 12
MeasGapConfig

| | |
|---|---|
| gapFR2 | SetupRelease {GapConfig} |
| gapFR1 | SetupRelease {GapConfig} |
| gapUE | SetupRelease {GapConfig} |

TABLE 13
GapConfig

| | |
|---|---|
| gapOffset | INTEGER {0...159} |
| Measurement gap length | ENUMERATED {1.5ms, 3ms, 3.5ms, 4ms, |
| (MGL) | 5.5ms, 6ms} |
| Measurement gap | ENUMERATED {20ms, 40ms, 80ms, 160ms} |
| repetition periodicity | |
| (MGRP) | |
| Measurement gap timing | ENUMERATED {0ms, 0.25ms, 0.5ms} |
| advance (MGTA) | |
| SSBCSIRxPoweroffset | ENUMERATED {0dB, −6dB} OPTIONAL |
| refServCellIndicator | ENUMERATED {pCell, pSCell, mcg-FR2} |

Referring to Table 13, the third exemplary embodiment may correspond to a case where an SSB channel state information reception power offset (SSBCSIRxPoweroffset) parameter is added to the GapConfig message. The base station may transmit third information indicating a difference between a reception power of an SSB beam transmitted by the neighbor cell and a reception power of a CSI-RS when measuring the neighbor cell. The terminal may receive the third information from the base station.

The base station may generate a GapConfig message including the third information indicating a difference between an SSB reception power for the SSB beam transmitted by the neighbor cell and a CSI-RS reception power in the SSB channel state information reception power offset (SSBCSIRxPoweroffset). The SSB channel state information reception power offset may indicate at least one of 0 dB or −6 dB. The SSB channel state information reception power offset set to 0 dB may indicate that a reception power of an SSB received through the SSB beam of the neighbor cell and a reception power measured through a CSI-RS are the same. The SSB channel state information reception power offset set to −6 dB may indicate that a reception power of an SSB received through the SSB beam of the neighbor cell is one-fourth of a reception power measured through a CSI-RS.

A fourth exemplary embodiment of Method 1 may be as shown in Table 14 and Table 15. Referring to Table 14, the fourth exemplary embodiment of Method 1 may correspond to a case where parameters are added to measurement gap configuration information. According to the present disclosure, three different measurement gap configurations may be possible. In other words, the measurement gap configuration information may include at least one of gapFR2, gapFR1, or gapUE1 information. A GapConfig message may be defined in the measurement gap configuration information. Information of the GapConfig message in the measurement gap configuration information configured through RRC signaling may be as shown in Table 15. The base station may generate a GapConfig message including the third information indicating a difference between an SSB reception power for the SSB beam transmitted by the neighbor cell (or the second base station) and a CSI-RS reception power in the SSB channel state information reception power offset (SSBCSIRxPoweroffset). The SSB channel state information reception power offset may indicate at least one of 0 dB, −3 dB, −5 dB, or −6 dB.

TABLE 14
MeasGapConfig

| | |
|---|---|
| gapFR2 | SetupRelease {GapConfig} |
| gapFR1 | SetupRelease {GapConfig} |
| gapUE | SetupRelease {GapConfig} |

TABLE 15
GapConfig

| | |
|---|---|
| gapOffset | INTEGER {0...159} |
| Measurement gap length | ENUMERATED {1.5ms, 3ms, 3.5ms, 4ms, |
| (MGL) | 5.5ms, 6ms} |
| Measurement gap | ENUMERATED {20ms, 40ms, 80ms, 160ms} |
| repetition periodicity | |
| (MGRP) | |
| Measurement gap timing | ENUMERATED {0ms, 0.25ms, 0.5ms} |
| advance (MGTA) | |
| SSBCSIRxPoweroffset | ENUMERATED {0dB, −3dB, −5dB, −6dB} |
| | OPTIONAL |
| refServCellIndicator | ENUMERATED {pCell, pSCell, mcg-FR2} |

The SSB channel state information reception power offset set to 0 dB may indicate that an SSB reception power for the SSB beam of the neighbor cell (or the second base station) and a reception power measured based on a CSI-RS are the same. The SSB channel state information reception power offset set to −3 dB may indicate that an SSB reception power for the SSB beam of the neighbor cell (or the second base station) is half a reception power measured based on a CSI-RS. The SSB channel state information reception power offset set to −5 dB may indicate that an SSB reception power for the SSB beam of the neighbor cell (or the second base station) is one-third of a reception power measured based on a CSI-RS. The SSB channel state information reception power offset set to −6 dB may indicate that an SSB reception power for the SSB beam of the neighbor cell (or the second base station) is one-fourth of a reception power measured based on a CSI-RS.

[Method 2: a Method in which First Information is Explicitly Notified to a Terminal by an Operating Cell (or a Serving Cell or a First Base Station) and Second Information is Notified to the Terminal by the Operating Cell (or the Serving Cell or the First Base Station)]

A neighbor cell (or a second base station) may transmit SSB through a wide SSB beam. The neighbor cell (or the second base station) may transmit SSB through a reference beam. A terminal may receive SSB from the neighbor cell (or the second base station). A reception power of an SSB for a wide SSB beam and a reception power of a data signal for the reference beam may be different. An error may occur in SSB-based measurement. To reduce the occurrence of the error, the base station may transmit SSB through a wide SSB beam so that a measurement value can be compensated. A first exemplary embodiment of Method 2 may be a method in which the operating cell (or the serving cell or the first base station) notifies terminals of information on a difference between a reception power of an SSB for the wide SSB beam and a reception power of a data signal for the reference beam through SIB 19. SIB 19 may include information on NTN operations. According to the first exemplary embodiment of Method 2, the information on the difference between a reception power of an SSB and a reception power for the reference beam according to the SIB 19 may include both first information and second information or may include only the second information. The first exemplary embodiment of Method 2 may be as shown in Table 16. Table 16 shows information on SSB transmission in an RRC reconfiguration message. NTN-Config-r17 may be a message to which configuration information for NTN operations is added in 3GPP Release 17. Referring to Table 16, the first exemplary embodiment of Method 2 may correspond to a case where an SSB reception power offset is added to the NTN-Config message of SIB 19. The SSB reception power offset may indicate a difference between a reception power of an SSB for the wide SSB beam and a reception power of a data signal for the reference beam. The SSBRxPoweroffset may indicate at least one of 0 dB or −6 dB.

TABLE 16
NTN-Config-r17

| | |
|---|---|
| epochTime-r17 | EpochTime-r17 OPTIONAL |
| ntn-UlSyncValidityDuration-r17 | ENUMERATED {s5, s10, s15, s20, s25, s30, s35, s40, |
| | s45, s50, s55, s60, s120, s180, s240} OPTIONAL |
| cellSpecificKoffset-r17 | INTEGER (0...1023) OPTIONAL |
| ServingcellSSBRxPoweroffset | ENUMERATED {0dB, −6dB} OPTIONAL |
| SSBRxPoweroffset | ENUMERATED {0dB, −6dB} OPTIONAL |
| kmac-r17 | INTEGER (0...512) OPTIONAL |
| ta-Info-r17 | TAInfo-r17 OPTIONAL |
| ntn-PolarizationDL-r17 | ENUMERATED {rhcp, lhcp, linear} OPTIONAL |
| ntn-PolarizationUL-r17 | ENUMERATED {rhcp, lhcp, linear} OPTIONAL |
| ephemerisInfo-r17 | EphemerisInfo-r17 OPTIONAL |
| ... | ... |

ServingcellSSBRxPoweroffset of Table 16 may indicate an SSB reception power offset of the operating cell (or the serving cell or the first base station). SSBRxPoweroffset of Table 16 may indicate an SSB reception power offset of the neighbor cell (or the second base station). The ServingcellSSBRxPoweroffset information may be transmitted through SIB 1 or the ServingcellSSBRxPoweroffset information may be obtained by the terminal through measurement of the terminal. Based on Table 16, the SSBRxPoweroffset set to 0 dB may indicate that a reception power of an SSB for the wide SSB beam and a reception power of a data signal for the reference beam are the same. The SSBRxPoweroffset set to −6 dB may indicate that a reception power of an SSB for the wide SSB beam is one-fourth of a reception power of a data signal for the reference beam. When the SSBRxPoweroffset is set to −6 dB, the base station may increase the number of beams used for SSB transmission by four times compared to the number of beams used for data and control channel transmission. When the SSBRxPoweroffset is set to −6 dB, the base station may increase the size of a beam used for SSB transmission by four times compared to the size of a beam used for data and control channel transmission.

The SSB reception power offset may be derived based on the size of the wide SSB beam and the size of the reference beam. For example, when the size of the wide SSB beam is two times larger than the size of the reference beam, a reception Signal-to-Noise Ratio (SNR) of the wide SSB beam may be 3 dB smaller than a reception SNR of the reference beam. The SSB reception power offset may vary depending on antenna characteristics used. When the SSB reception power offset is derived based on the size of the wide SSB beam and the size of the reference beam, the beam size may be based on a UV plane beam layout or may be based on a beam layout on the ground (e.g. a latitude-longitude beam layout).

A second exemplary embodiment of Method 2 may be as shown in Table 17. Table 17 shows information on SSB transmission in an RRC reconfiguration message. NTN-Config-r17 may be a message to which configuration information for NTN operations is added in 3GPP Release 17. Referring to Table 16, the second exemplary embodiment of Method 2 may correspond to a case where an SSB reception power offset is added to the NTN-Config message of SIB 19. The SSB reception power offset may indicate a difference between a reception power of an SSB for the wide SSB beam and a reception power of a data signal for the reference beam. The SSB reception power offset may indicate at least one of 0 dB or −6 dB. The SSB reception power offset may include information on a reception power of an SSB for the wide SSB beam and a reception power of a data signal for the reference beam. The SSB reception power offset may indicate at least one of 0 dB, −3 dB, −5 dB, or −6 dB.

TABLE 17
NTN-Config-r17

| | |
|---|---|
| epochTime-r17 | EpochTime-r17 OPTIONAL |
| ntn-UlSyncValidityDuration-r17 | ENUMERATED {s5, s10, s15, s20, s25, s30, s35, s40, |
| | s45, s50, s55, s60, s120, s180, s240} OPTIONAL |
| cellSpecificKoffset-r17 | INTEGER (0...1023) OPTIONAL |
| ServingcellSSBRxPoweroffset | ENUMERATED {0dB, −3dB, −5dB, −6dB} OPTIONAL |
| SSBRxPoweroffset | ENUMERATED {0dB, −3dB, −5dB, −6dB} OPTIONAL |
| kmac-r17 | INTEGER (0...512) OPTIONAL |
| ta-Info-r17 | TAInfo-r17 OPTIONAL |
| ntn-PolarizationDL-r17 | ENUMERATED {rhcp, lhcp, linear} OPTIONAL |
| ntn-PolarizationUL-r17 | ENUMERATED {rhcp, lhcp, linear} OPTIONAL |
| ephemerisInfo-r17 | EphemerisInfo-r17 OPTIONAL |
| ... | ... |

Based on Table 17, ServingcellSSBRxPoweroffset may indicate an SSB reception power offset of the operating cell (or the serving cell or the first base station). SSBRxPoweroffset may indicate an SSB reception power offset of the neighbor cell (or the second base station). The SSB reception power offset set to 0 dB may indicate that an SSB reception power for the wide SSB beam and a reception power of a data signal for the reference beam are the same. The SSB reception power offset set to −3 dB may mean that an SSB reception power for the wide SSB beam is half a reception power of a data signal for the reference beam. The SSB reception power offset set to −5 dB may mean that an SSB reception power for the wide SSB beam is one-third of a reception power of a data signal for the reference beam. The SSB reception power offset set to −6 dB may indicate that an SSB reception power for the wide SSB beam is one-fourth of a reception power of a data signal for the reference beam. The SSB reception power offset may be derived based on the size of the wide SSB beam and the size of the reference beam. For example, when the size of the wide SSB beam is two times larger than the size of the reference beam, a reception SNR of the wide SSB beam may be 3 dB smaller than a reception SNR of the reference beam. The SSB reception power offset may also vary depending on antenna characteristics used. When a difference in reception power between the wide SSB beam and the reference beam (i.e. the SSB reception power offset) is derived based on the sizes of the wide SSB beam and the reference beam, the beam size may be based on a UV plane beam layout or may be based on a beam layout on the ground (e.g. a latitude-longitude beam layout).

Values of the SSB reception power offset described in the present disclosure are merely exemplary embodiments and may have various values not described in the present disclosure. When an SSB beam that is narrower than the reference beam is used, a value of the SSB reception power offset may have a positive value (e.g. +3 dB). The unit dB used in the present disclosure is merely one example for description of exemplary embodiments, and other units may be used. In providing a reception power ratio according to the present disclosure, the base station may provide to the terminal information indicating a size ratio, such as an SSB transmission range offset (SSBTxRangeoffset), instead of the SSB reception power offset indicating a power ratio. It should be noted that the SSB reception power offset can be replaced with another parameter from which a reception power ratio can be derived.

### [Method 3: a Method of Notifying a Terminal of Information on a Difference Between a Reception Power of a Reference Beam and a Reception Power of a Wide SSB Beam Through a ServingCellConfigCommon Message]

A base station may transmit SSB to a terminal through a wide SSB beam. The base station may transmit a data signal to the terminal through a narrow beam. In this case, a difference between an SSB reception power for the wide SSB beam and a reception power of the data signal for the narrow beam may be different from a difference between a reception power of a data signal for a reference beam and a reception power of a data signal for the narrow beam. A problem that an error occurs in SSB-based measurement may occur. The error may occur when the terminal does not know the difference between the SSB reception power for the wide SSB beam and the reception power of the data signal for the reference beam.

To solve the above-described problem, compensation for an SSB-based measurement value may be required. A first exemplary embodiment of Method 3 may be as shown in Table 18. Based on Table 18, a ServingCellConfigCommon message may include information on SSB transmission. The base station may notify terminals, through the ServingCellConfigCommon message, of information on the difference between a reception power of the data signal for the reference beam and an SSB reception power for the wide beam. The first exemplary embodiment of Method 3 may correspond to a case where an SSB reception power offset is added to the ServingCellConfigCommon message. The ServingCellConfigCommon message may include an SSB reception power offset indicating information on the difference between the reception power of the data signal for the reference beam and the SSB reception power for the wide SSB beam. The SSB reception power offset may indicate at least one of 0 dB or −6 dB.

TABLE 18
ServingCellConfigCommon

| | | |
|---|---|---|
| ssb-PositionsInBurst | shortBitmap | BIT STRING (SIZE (4)) |
| | mediumBitmap | BIT STRING (SIZE (8)) |
| | longBitmap | BIT STRING (SIZE (64)) |

| | |
|---|---|
| ssb-periodicityServingCell | ENUMERATED {5ms, 10ms, 20ms, 40ms, 80ms, 160ms, |
| | spare2, spare1} |
| SSBRxPoweroffset | ENUMERATED {0dB, −6dB} OPTIONAL |

Based on Table 18, an SSB reception power offset set to 0 dB may indicate that a reception power of a data signal for the reference beam and an SSB reception power for the wide SSB beam are the same. The SSB reception power offset set to −6 dB may indicate that an SSB reception power for the wide beam is one-fourth of a reception power of a data signal for the reference beam. In other words, the base station may increase the number of beams used for SSB transmission by four times compared to the number of beams used for data and control channel transmission. The base station may increase the size of a beam used for SSB transmission by four times compared to the size of a beam used for data and control channel transmission.

TABLE 19
ServingCellConfigCommon

| | | |
|---|---|---|
| ssb-PositionsInBurst | shortBitmap | BIT STRING (SIZE (4)) |
| | mediumBitmap | BIT STRING (SIZE (8)) |
| | longBitmap | BIT STRING (SIZE (64)) |

| | |
|---|---|
| ssb-periodicityServingCell | ENUMERATED {5ms, 10ms, 20ms, 40ms, 80ms, 160ms, |
| | spare2, spare1} |
| SSBRxPoweroffset | ENUMERATED {0dB, −3dB, −5dB, −6dB} OPTIONAL |

Based on Table 19, a second exemplary embodiment of Method 3 may correspond to a case where the SSB reception power offset is added to the ServingCellConfigCommon message. The SSB reception power offset may indicate a difference between a reception power of the data signal for the reference beam and an SSB reception power for the wide SSB beam. The SSB reception power offset may indicate at least one of 0 dB, −3 dB, −5 dB, or −6 dB. The SSB reception power offset set to 0 dB may indicate that a reception power of a data signal for the reference beam and an SSB reception power for the wide SSB beam are the same. The SSB reception power offset set to −3 dB may indicate that an SSB reception power for the wide SSB beam is half a reception power of a data signal for the reference beam. The SSB reception power offset set to −5 dB may indicate that an SSB reception power for the wide SSB beam is one-third of an SSB reception power for the reference beam. The SSB reception power offset set to −6 dB may indicate that an SSB reception power for the wide SSB beam is one-fourth of a reception power of a data signal for the reference beam. The SSB reception power offset may be derived based on the size of the wide SSB beam and the size of the reference beam. For example, when the size of the wide SSB beam is two times larger than the size of the reference beam, a reception SNR of the wide SSB beam may be 3 dB smaller than a reception SNR of the reference beam. The difference between an SSB reception power for the wide SSB beam and a reception power of a data signal for the reference beam (i.e. SSB reception power offset) may vary depending on antenna characteristics used. When the SSB reception power offset is derived based on the sizes of the wide SSB beam and the reference beam, the beam sizes may be based on a UV plane beam layout. Alternatively, the beam sizes may be based on a beam layout on the ground (e.g. a latitude-longitude beam layout).

Values of the SSB reception power offset in the present disclosure are merely exemplary embodiments and may have various values not described. The SSB beam may be a beam that is narrower than the reference beam, and in this case, a value of the SSB reception power offset may have a positive value (e.g. +3 dB). The unit dB used in the present disclosure is merely one example for description of exemplary embodiments, and other units may also be used. In providing a reception power ratio according to the present disclosure, the base station may provide to the terminal information indicating a size ratio, such as an SSB transmission range offset, instead of the SSB reception power offset indicating a power ratio. It should be noted that the reception power ratio can be replaced with another parameter from which the reception power ratio can be derived.

### [Method 4: a Method of Notifying a Terminal of Information on a Difference Between a Reception Power of a Data Signal for a Reference-Beam and a Reception Power of SSB for a Wide SSB Beam Through SIB 1]

A base station may transmit SSB to terminals through a wide SSB beam. The base station may transmit a data channel and a control channel to the terminals through a narrow beam. A difference between an SSB reception power for the wide SSB beam and a reception power of a data signal for the narrow beam may be different from a difference between an SSB reception power for a reference beam and a reception power of a data signal for the narrow beam. An error may occur in SSB-based measurement. The error may occur when the terminal does not know a difference between an SSB reception power for the wide SSB beam and an SSB reception power for the reference beam.

In order to solve the above-described problem, a method of compensating for a measurement value based on SSB may be provided. A ServingCellConfigCommonSIB message of SIB 1 may include information on SSB transmission. A method for notifying terminals of information on a difference between a reception power of an SSB for the reference beam and a reception power of an SSB for the wide SSB beam through the ServingCellConfigCommonSIB message of SIB 1 may be provided. A first exemplary embodiment of Method 4 may correspond to a case of adding an SSBRxPoweroffset to the ServingCellConfigCommonSIB message. The ServingCellConfigCommonSIB message may include an SSB reception power offset indicating a difference between a reception power of a data signal for the reference beam and a reception power of an SSB for the wide SSB beam. The SSB reception power offset may indicate at least one of 0 dB and −6 dB.

TABLE 20
ServingCellConfigCommonSIB

| | | |
|---|---|---|
| ssb-PositionsInBurst | inOneGroup | BIT STRING (SIZE (8)) |
| | groupPresence | BIT STRING (SIZE (8)) |

| | |
|---|---|
| ssb-periodicityServingCell | ENUMERATED {5ms, 10ms, 20ms, 40ms, 80ms, 160ms} |
| SSBRxPoweroffset | ENUMERATED {0dB, −6dB} OPTIONAL |

A second exemplary embodiment of Method 4 may be as shown in Table 20. Based on Table 20, the second exemplary embodiment of Method 4 may correspond to a case of adding an SSB reception power offset to the ServingCellConfigCommonSIB message. The ServingCellConfigCommonSIB message may include the SSB reception power offset indicating a difference between a reception power of a data signal for the reference beam and a reception power of an SSB for the wide SSB beam. The SSB reception power offset set to 0 dB may indicate that a reception power of a data signal for the reference beam and a reception power of an SSB for the wide SSB are the same. The SSB reception power offset set to −6 dB may indicate that a reception power of an SSB for the wide SSB beam is one-fourth of a reception power of a data signal for the reference beam. In other words, the base station may increase the number of beams used for SSB transmission by four times compared to the number of beams used for data and control channel transmission. The base station may increase the size of a beam used for SSB transmission by four times compared to the size of a beam used for data channel and control channel transmission.

TABLE 21
ServingCellConfigCommonSIB

| | | |
|---|---|---|
| ssb-PositionsInBurst | inOneGroup | BIT STRING (SIZE (8)) |
| | groupPresence | BIT STRING (SIZE (8)) |

| | |
|---|---|
| ssb-periodicityServingCell | ENUMERATED {5ms, 10ms, 20ms, 40ms, 80ms, 160ms} |
| SSBRxPoweroffset | ENUMERATED {0dB, −3dB, −5dB, −6dB} OPTIONAL |

The second exemplary embodiment of Method 4 may be as shown in Table 21. Based on Table 21, the second exemplary embodiment of Method 4 may correspond to a case of adding an SSB reception power offset parameter to the ServingCellConfigCommonSIB message. The ServingCellConfigCommonSIB message may include an SSB reception power offset indicating information on a difference between a reception power of a data signal for the reference beam and a reception power of an SSB for the wide SSB beam. The SSB reception power offset may indicate at least one of 0 dB, −3 dB, −5 dB, and −6 dB. The SSB reception power offset set to 0 dB may indicate that a reception power of an SSB for the reference beam and a reception power of an SSB for the wide SSB beam are the same. The SSB reception power offset set to −3 dB may indicate that a reception power of an SSB for the wide SSB beam is half a reception power of a data signal for the reference beam. The SSB reception power offset set to −5 dB may indicate that a reception power of an SSB for the wide SSB beam is one-third of a reception power of a data signal for the reference beam. The SSB reception power offset set to −6 dB may indicate that a reception power of an SSB for the wide SSB beam is one-fourth of a reception power of a data signal for the reference beam.

### [Method 5: Method for Reporting SS-RSRP and CSI-RSRP Considering a Difference Between a Reception Power of an SSB for a Reference Beam and a Reception Power of an SSB for a Wide SSB Beam]

A terminal may perform measurement reporting of reference signal received power (RSRP) to a base station. When measuring synchronization signal-RSRP (SS-RSRP) for the measurement reporting, an RSRP calculation equation reflecting a difference between a reception power of a reference beam and a reception power of a wide beam may be as expressed in Equation 1.

$$RSRP value [ dBm ] = reported value - 156 - SSBxPoweroffset \qquad [ Equation 1 ]$$

RSRP value may denote an RSRP value. The base station may transmit information on SSBRxPoweroffset to the terminal. The terminal may calculate RSRP values using SSBRxPoweroffset information received from the base station. The terminal may report RSRP values to the base station.

When a reporting range of a difference between SS-RSRP and CSI-RSRP is from 0 dB to −30 dB, SSBRxPoweroffset may be applied, and the reporting range may have a positive dB value. Therefore, when a difference between SS-RSRP and CSI-RSRP is denoted as Y [dB], a method for updating the reporting range to (Y-SSBRxPoweroffset) may be provided. In other words, when the reporting range is (Y-SSBRxPoweroffset), the reporting range of the difference between SS-RSRP and CSI-RSRP may be from −SSBRxPoweroffset dB to −30-SSBRxPoweroffset dB.

$$SS - RSRQ [ dB ] = [ ( SS - RSRP ) - \frac{SSBxPoweroffset}{RSSI} ] \times N \qquad [ Equation 2 ]$$

For measurement reporting of reference signal received quality (RSRQ) of the terminal, synchronization signal-RSRQ (SS-RSRQ) may be measured. When measuring SS-RSRQ, a calculation equation reflecting a difference between a reception power of the reference beam and a reception power of the wide beam may be as expressed in Equation 2. RSSI may denote a received signal strength indicator. N may denote the number of resource blocks. The base station may transmit information on SSBRxPoweroffset to the terminal. The terminal may calculate RSRQ values using SSBRxPoweroffset received from the base station, and the terminal may report RSRQ values to the base station.

A difference (SSBRxPoweroffset) between a reception power of an SSB for the wide SSB beam and a reception power of a data signal for the reference beam may be derived based on the sizes of the wide SSB beam and the reference beam. For example, when the size of the wide SSB beam is two times larger than the size of the reference beam, a reception SNR of the wide SSB beam may be 3 dB smaller than a reception SNR of the reference beam. The reception power difference may vary depending on antenna characteristics used. The difference (SSBRxPoweroffset) between a reception power for the wide SSB beam and a reception power for the reference beam may be derived based on the sizes of the wide SSB beam and the reference beam. In this case, the beam sizes may be based on a UV plane beam layout. The beam sizes may be based on a beam layout on a ground surface (e.g. latitude-longitude beam layout).

The values of the SSB reception power offset described by the present disclosure are merely exemplary embodiments, and various values not described in the present disclosure may be used. In the present disclosure, The SSB beam may be a beam (e.g. narrow beam) smaller in size than the reference beam. In the case of using a narrow SSB beam, a value of the SSB reception power offset may be a positive value (e.g. 3 dB). A unit dB used in the present disclosure is merely an example for describing the exemplary embodiment, and other units may be used. In the present disclosure, the base station may provide information representing a size ratio such as an SSB transmission range offset to the terminal instead of the SSB reception power offset representing a reception power ratio. The SSB reception power offset may be replaced with another parameter from which a reception power ratio can be derived. For example, the SSB reception power offset may be replaced with an SSB channel state information reception power offset. The SSB channel state information reception power offset may include information indicating a difference between a reception power of a signal for a wide beam of a neighbor cell (or the second base station) and CSI-RSRP.

The base station may use the SSB reception power offset or the SSB channel state information reception power offset. By using the parameter, the base station may indicate to the terminal a difference in reception power of an SSB according to a change in beam size. The transmission and reception method of the present disclosure may also be applied to a system transmitting signals through SSB beams of the same size when a dynamic power allocation scheme for the SSB beams is applied. The base station may notify a difference in reception power caused by dynamic power allocation for SSB beams of the same size by using the SSB reception power offset or the SSB channel state information reception power offset.

[Method 6: Method for Applying an SSB Transmission Power to a Base Station and a Terminal when the Base Station Dynamically Varies the SSB Transmission Power]

Method 1, Method 2, Method 3, Method 4, or Method 5 described above may be exemplary embodiments based on a reception power ratio between a wide SSB beam and a reference SSB beam. Method 1, Method 2, Method 3, Method 4, or Method 5 described above may be applied to a communication system dynamically varying an SSB transmission power. Method 1, Method 2, Method 3, Method 4, or Method 5 described above may be applied to improve signal overhead and latency. In other words, when the base station frequently varies the SSB transmission power, the base station may transmit information on the SSB transmission power, information on a CSI-RS transmission power, or power offset information to the terminal. The terminal may receive the information on the SSB transmission power, information on the CSI-RS transmission power, or the power offset information from the base station. When the base station dynamically varies a transmission power of a reference beam, the base station may transmit information the SSB transmission power, information on the CSI-RS transmission power, or power offset information. In other cases, the base station may not transmit information on the SSB transmission power, information on the CSI-RS transmission power, or power offset information. Method 1 to Method 5 of the disclosure may be used in a case of delivering an SSB reception power offset or a transmission power offset of an SSB beam having a smaller power compared to the reference beam. The methods may be applied to various communication systems in which wide beams and narrow beams are used.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
acquiring, from a first base station, first information indicating a difference between a reception power of a first reference beam of the first base station and a reception power of a first synchronization signal block (SSB) beam of the first base station;
receiving, from the first base station, second information indicating a difference between a reception power of a second reference beam of a second base station and a reception power of a second SSB beam of the second base station;
measuring a first signal received from the first base station;
measuring a second signal received from the second base station; and
selecting a cell operated by at least one of the first base station or the second base station based on at least one of a first measurement result of the first signal, a second measurement result of the second signal, the first information, or the second information.

2. The method of claim 1, wherein the first reference beam is a narrow beam, and the first SSB beam is a narrow beam.

3. The method of claim 1, wherein the second reference beam is a narrow beam, and the second SSB beam is a wide beam.

4. The method of claim 1, wherein the first signal is a data signal received through the first reference beam or an SSB received through the first SSB beam.

5. The method of claim 1, wherein the second signal is a data signal received through the second reference beam or an SSB received through the second SSB beam.

6. The method of claim 1, wherein the first information includes a first SSB reception power offset indicating a reception power difference between the first reference beam and the first SSB beam, and the second information includes a second SSB reception power offset indicating a reception power difference between the second reference beam and the second SSB beam.

7. The method of claim 6, wherein the cell is determined based on at least one of information determined based on the first measurement result and the first SSB reception power offset, or information determined based on the second measurement result and the second SSB reception power offset.

8. A terminal comprising at least one processor, wherein the at least one processor causes the terminal to perform:
acquiring, from a first base station, first information indicating a difference between a reception power of a first reference beam of the first base station and a reception power of a first synchronization signal block (SSB) beam of the first base station;
receiving, from the first base station, second information indicating a difference between a reception power of a second reference beam of a second base station and a reception power of a second SSB beam of the second base station;
measuring a first signal received from the first base station;
measuring a second signal received from the second base station; and
selecting a cell operated by at least one of the first base station or the second base station based on at least one of a first measurement result of the first signal, a second measurement result of the second signal, the first information, or the second information.

9. The terminal of claim 8, wherein the first reference beam is a narrow beam, and the first SSB beam is a narrow beam.

10. The terminal of claim 8, wherein the second reference beam is a narrow beam, and the second SSB beam is a wide beam.

11. The terminal of claim 8, wherein the first signal is a data signal received through the first reference beam or an SSB received through the first SSB beam.

12. The terminal of claim 8, wherein the second signal is a data signal received through the second reference beam or an SSB received through the second SSB beam.

13. The terminal of claim 8, wherein the first information includes a first SSB reception power offset indicating a reception power difference between the first reference beam and the first SSB beam, and the second information includes a second SSB reception power offset indicating a reception power difference between the second reference beam and the second SSB beam.

14. The terminal of claim 13, wherein the cell is determined based on at least one of information determined based on the first measurement result and the first SSB reception power offset, or information determined based on the second measurement result and the second SSB reception power offset.

15. A method of a first base station, comprising:
transmitting, to a terminal, first information indicating a difference between a reception power of a first reference beam of the first base station and a reception power of a first synchronization signal block (SSB) beam of the first base station;
transmitting, to the terminal, second information indicating a difference between a reception power of a second reference beam of a second base station and a reception power of a second SSB beam of the second base station;
transmitting, to the terminal, a first signal using the first reference beam or the first SSB beam; and
performing communication with the terminal through a cell of the first base station selected based on at least one of the first information, the second information, a measurement result of a second signal transmitted by the second base station, or a measurement result of the first signal.

16. The method of claim 15, wherein the first reference beam is a narrow beam, and the first SSB beam is a narrow beam.

17. The method of claim 15, wherein the second reference beam is a narrow beam, and the second SSB beam is a wide beam.

18. The method of claim 15, wherein the first information includes a first SSB reception power offset indicating a reception power difference between the first reference beam and the first SSB beam, and the second information includes a second SSB reception power offset indicating a reception power difference between the second reference beam and the second SSB beam.
